(19) United States
(12) Patent Application Publication
(10) Pub. No.: US 2009/0064728 A1
(43) Pub. Date: Mar. 12, 2009

(54) WASHING MACHINE WITH DOUBLE ROTOR TYPE MOTOR

(75) Inventors: Soung Bong Choi, Gyeongsangnam-do (KR); Hung Myong Cho, Gyeongsangnam-do (KR)

Correspondence Address: KED & ASSOCIATES, LLP, P.O. Box 221200, Chantilly, VA, 20153-1200, US

(73) Assignee: LG ELECTRONICS, Seoul (KR)

(21) Appl. No.: 11/547,097

(22) PCT Filed: Feb. 1, 2006
(86) PCT No.: PCT/KR2006/000353

§ 371 Date: Nov. 13, 2008

(30) Foreign Application Priority Data
Feb. 1, 2005 (KR) 10-2005-0009154
Feb. 1, 2005 (KR) 10-2005-0009156

(51) Int. Cl. H02K 1/22

(52) U.S. Cl. 68/140

(57) ABSTRACT

The present invention relates to washing machines with double rotor type motors, and more particularly, to a washing machine with a double rotor type motor in which a structure for mounting a bearing housing thereof is enhanced. To achieve the object of the present invention, the present invention provides a washing machine including a tub for holding washing water, a double rotor having an outer rotor with outer magnets supported on an inside circumferential surface, and an inner rotor on an inner side of the outer rotor with inner magnets supported on outside circumferential surface, a bearing housing at a rear of the tub for supporting a rotation shaft connected to the double rotor, a cover insert molded with the tub as one body therewith, to cover an outside surface of the bearing housing, and a stator having cores with opposite surfaces arranged to face the outer magnets and inner magnets respectively, a coil wound on an outside surface of each of the cores, a molded portion insert molded to outside surfaces of the core and coil so as to be exposed to the opposite surfaces of the core, and a fixing portion extended from the molded portion and secured to the fastening portion.

### TECHNICAL FIELD

The present invention relates to washing machines with double rotor type motors, and more particularly, to a washing machine with a double rotor type motor in which a structure for mounting a bearing housing thereof is enhanced.

### BACKGROUND ART

In general, the washing machine washes laundry by using friction between washing water and the laundry in a drum rotated by a motor in a state detergent, washing water, and the laundry is introduced into the drum. The drum is a washing tub for holding washing water and the laundry, and applicable to the washing machine, irrespective of the washing machine being of a drum type or a pulsator type.

In the meantime, depending on driving types of the washing machine, there are indirect coupling type in which driving power is transmitted from the motor to the drum indirectly through a belt wound around a motor pulley and a drum pulley, and a direct coupling type in which the motor is directly coupled to the drum, to transmit driving power from the motor to the drum, directly.

The type of washing machine in which driving power is transmitted from the motor to the drum indirectly through a belt wound around a motor pulley and a drum pulley causes an energy loss in a course of the driving power transmission, and generates much noise in the power transmission course. Consequently, in order to solve such problems, it is a recent trend that use of washing machines having the direct coupling drum type motors applied thereto increases.

FIG. 1 illustrates a section of a related art drum type washing machine with a motor.

Referring to FIG. 1, there is a tub 2 in a cabinet 1, with a drum 3 rotatably mounted on a center of an inside of the tub 2.

At a rear of the tub 2, there is a motor having a stator 6 and a rotor 5, wherein the stator 6 is fixedly secured to a rear wall of the tub, and the rotor 5 surrounds the stator 6, and is fixed to a shaft passed through the tub and connected to the drum 3. Though not shown in detail, on an inside surface of the rotor 5, there are magnets of opposite poles arranged alternately.

In the meantime, there is a door 21 on a front of the cabinet 1, with a gasket 22 between the door 21 and the tub 2. There are hanging springs 23 between an inside of an upper side of the cabinet 1 and an upper side of an outside circumference of the tub 2, for suspending the tub 2, and friction dampers 24 between an inside of a lower side of the cabinet 1 and a lower side of an outside circumference of the tub 2 for damping vibration of the tub 2 generated in spinning.

Together with this, there is a metal tub supporter (not shown) between the tub rear wall and the stator, having a shape in conformity with an exterior shape of the rear wall of the tub 2, to be fixedly secured to the rear wall of the tub at the time the stator is secured, for supporting a weight of the stator, and maintaining concentricity of the stator.

The stator 6 functions as an electromagnet when power is supplied thereto, when the rotor rotates by action of a rotating magnetic field between the magnets of the stator 6 and the rotor 5, and rotation power of the rotor 5 is transmitted to the drum through the rotation shaft 4.

Currently, keeping pace with capacity increase of the washing machine, though it is required to increase an output of the motor for rotating the drum too, such an increased output of the motor requires large sized rotor and stator, to increase size and weight of the motor, significantly.

Consequently, the inventor suggests a double rotor type motor disclosed in Korea Patent Laid Open No. 2001-0097204 (applied on Nov. 8, 2001) having a stator with coils wound on inside and outside, and a double rotor of an inner rotor and an outer rotor on an inner side and an outer side of the stator each with a gap from the stator respectively, for increasing the output.

As the double rotor type motor generates greater power, it is required that the double rotor type motor is mounted to the washing machine or the like, more rigidly. Accordingly, the present invention modifies a structure for mounting the double rotor type motor to the washing machine further.

### DISCLOSURE OF INVENTION

### Technical Problem

An object of the present invention is to provide a washing machine having a structure modified further for mounting a double rotor type motor thereto.

### Technical Solution

The object of the present invention can be solved by providing a washing machine including a tub for holding washing water, a double rotor having an outer rotor with outer magnets supported on an inside circumferential surface, and an inner rotor inside the outer rotor with inner magnets supported on outside circumferential surface, a bearing housing at a rear of the tub for supporting a rotation shaft connected to the double rotor, a cover insert molded with the tub as one body therewith, to cover an outside surface of the bearing housing, and a stator having cores with opposite surfaces arranged to face the outer magnets and the inner magnets respectively, a coil wound on an outside surface of each of the cores, a molded portion insert molded to outside surfaces of the core and coil so as to be exposed to the surfaces of the core, and a fixing portion extended from the molded portion and secured to the fastening portion.

The bearing housing includes a supporting portion for holding bearing to support a rations shaft, and, preferably, a fastening portion extended from the supporting portion.

The fastening portion is extended in a radial direction of the bearing housing. A plurality of the fastening portions are formed in a circumferential direction of the bearing housing at predetermined angular intervals. It is preferable that there are vertical ribs between the plurality of fastening portions. The ribs, not only reinforce strength, but also enhances bonding force with the cover.

More preferably, the plurality of fastening portions are connected continuously, with a projected portion at each connected portion. According to this, the bearing housing includes the fastening portions extended from the supporting portion in a radial direction, with steps in a circumferential direction. This shape serves to reinforces strength and rigidity and enhances bonding force with the cover.

Moreover, it is preferable that the fastening portion has at least two steps in a radial direction. According to this, strength is reinforced, a contact area with the cover becomes larger at the time of insert molding, and bonding with the cover becomes more positive owing to contact to a non-smooth surface.

The fixing portion is insert molded with the molded portion as one body. The fixing portion is extended from the molded portion inwardly in a radial direction, or outwardly in the radial direction. The fastening portion and the fixing portion each has at least one fastening hole at positions corresponding to each other for fastening a fastening member.

The washing machine further includes a positioning unit for determining a fixing position of the fixing portion with respect to the fastening portion. The positioning unit includes at least one positioning projection projected from one of the fixing portion and the fastening portion, and at least one positioning hole formed in the other one of the fixing portion and the fastening portion in correspondence to the positioning projection.

The positioning projection includes a cylindrical body portion, and a guide portion at an end of the body portion having a diameter reduced the more as it goes toward an end the more. The positioning hole includes a cylindrical portion in correspondence to the body portion, and a reduced portion at an end of the cylindrical portion in correspondence to the guide portion. The positioning hole has a diameter smaller than a diameter of the fastening hole in the fixing portion.

The bearing housing has holding holes for filling molding material therein at the time of insert molding of the cover, for bonding the bearing housing and the cover together. The fixing portion includes a reinforcing portion for reinforcing strength of the fixing portion. The reinforcing portion includes a plurality of reinforcing ribs at an outside surface of the fixing portion as one body therewith. The cover includes a plurality of reinforcing ribs formed as one body therewith for reinforcing strength. There is an insulator of an insulating resin between the core and the molded portion.

In another aspect of the present invention, a washing machine includes a tub for holding washing water, a double rotor having an outer rotor with outer magnets supported on an inside circumferential surface, and an inner rotor inside the outer rotor with inner magnets supported on outside circumferential surface, a bearing housing at a rear of the tub, having a supporting portion for supporting a rotation shaft connected to the double rotor, and a fastening portion extended in a radial direction from the supporting portion, a cover insert molded with the tub as one body therewith for covering an outside surface of the bearing housing and securing the bearing housing, having a plurality of reinforcing ribs for reinforcing strength, and a stator having cores with opposite surfaces arranged to face the outer magnets and the inner magnets respectively, an insulator of insulating resin on an outside surface of the core, a coil wound on an outside surface of the insulator, a molded portion insert molded to outside surfaces of the core and coil so as to be exposed to the opposite surfaces of the core, and a fixing portion extended from the molded portion in a radial direction and secured to the fastening portion.

In another aspect of the present invention, a washing machine includes a tub for holding washing water, a double rotor having an outer rotor with outer magnets supported on an inside circumferential surface, and an inner rotor inside the outer rotor with inner magnets supported on outside circumferential surface, a bearing housing at a rear of the tub, having a supporting portion for supporting a rotation shaft connected to the double rotor, and a fastening portion extended in a radial direction from the supporting portion, a cover insert molded with the tub as one body therewith for covering an outside surface of the bearing housing and securing the bearing housing, having a plurality of reinforcing ribs for reinforcing strength, and a stator having cores with opposite surfaces arranged to face the outer magnets and the inner magnets respectively, an insulator of insulating resin on an outside surface of the core, a coil wound on an outside surface of the insulator, and a fixing portion extended from the insulator in a radial direction and secured to the fastening portion.

### ADVANTAGEOUS EFFECTS

The washing machine of the present invention having the double rotor type motor applied thereto has the following advantages.

First, the securing of the bearing housing with the cover insert molded with the nib as one body-permits to secure the double rotor type motor that provides a high torque, securely.

Second, the securing of the bearing housing with the cover, covering the bearing housing, insert molded with the tub as one body permits to omit the step for mounting the bearing housing to the rear of the tub. According to this, the assembly process can be simplified, to shorten a production time period of the product.

Third, the fastening portion extended from the supporting portion of the bearing housing in a radial pattern is coupled to the stator and reinforces the rear of the nib.

Fourth, if the supporting portion of the bearing housing is exposed to an outside at the time of insert molding of the cover, the flow of the molding material into the fastening holes in the supporting portion can be prevented, thereby preventing defects from taking place.

Fifth, the shortening of a time period required for aligning the bearing housing and the stator by using the positioning unit permits to shorten a production time period.

Thus, by improving a structure for mounting a motor to the washing machine such that driving power is transmitted from the motor to the drum directly, the present invention reduces noise and faults, as well as a power loss, to improve washing capability and product reliability, and to improve processability of components of the driving unit, to improve productivity in fabrication of the product.

### BRIEF DESCRIPTION OF THE DRAWINGS

FIG. 1 illustrates a section of a related art washing machine;

FIG. 2 illustrates a partial section of a structure for mounting a double rotor type motor in accordance with a preferred embodiment of the present invention;

FIG. 3 illustrates an exploded perspective view of a double rotor type motor in accordance with a preferred embodiment of the present invention;

FIG. 4 illustrates a partial cut-away perspective view of a tub rear portion in accordance with a preferred embodiment of the present invention;

FIG. 5 illustrates a perspective view of a bearing housing in accordance with a preferred embodiment of the present invention;

FIG. 6 illustrates a perspective view of a structure for mounting a double rotor type motor in accordance with another preferred embodiment of the present invention; and

FIG. 7 illustrates another preferred embodiment of the present invention.

### BEST MODE FOR CARRYING OUT THE INVENTION

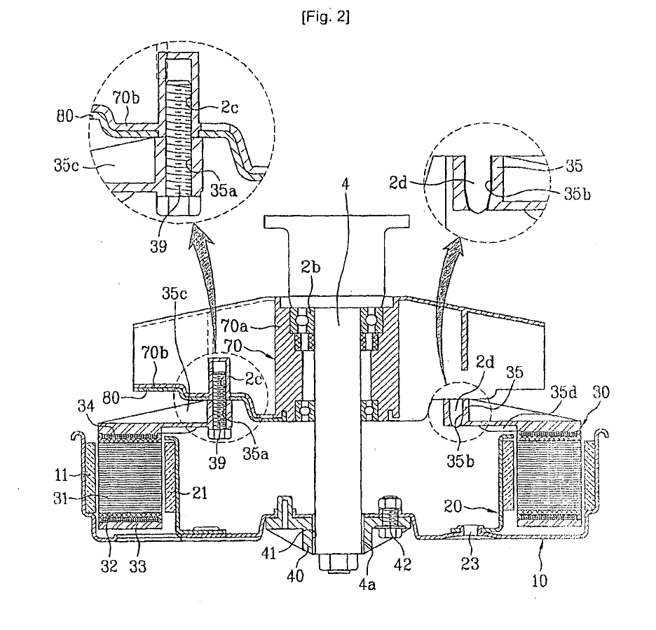

Reference will now be made in detail to the preferred embodiments of the present invention, examples of which are illustrated in the accompanying drawings FIGS. 2 to 6.

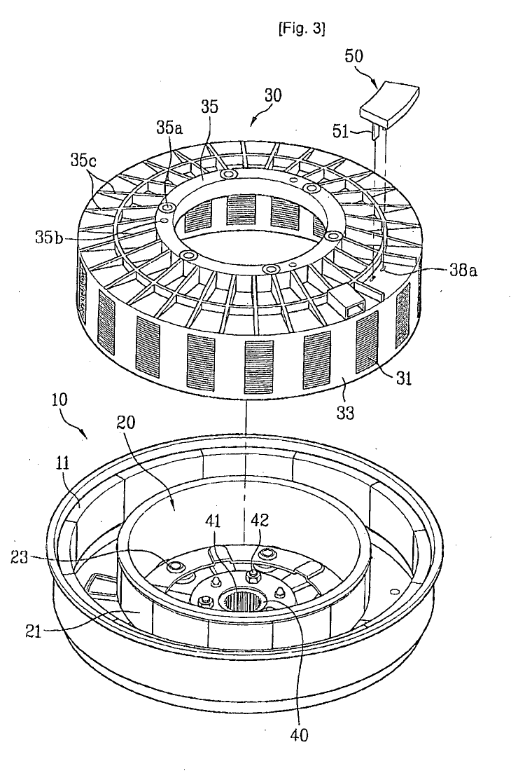

FIG. 2 illustrates a section of a structure for mounting a double rotor type motor in accordance with a preferred embodiment of the present invention, and FIG. 3 illustrates an exploded perspective view of a double rotor type motor in accordance with a preferred embodiment of the present invention.

Referring to FIGS. 2 and 3, the double rotor type motor includes an outer rotor 10, an inner rotor 20, and a stator 30. Placed between the outer rotor 10 and the inner rotor 20, there is the stator 30, and a top side of the stator 30 is fixedly secured to a rear of a washing machine tub.

In more detail, the top side of the stator 30 is fixedly secured to one side of a bearing housing ‘B’ mounted to a rear of the stator, and a bottom side of the stator 30 is placed between the outer rotor 10 and the inner rotor 20. In this instance, an outside circumferential surface and an inside circumferential surface of the stator 30 have pre-determined gaps to an inside circumferential surface of the outer rotor and an outside circumferential surface of the inner rotor, respectively. At one side of the stator 30, there is a hall sensor 50 for detecting a rotation speed of the double rotor. The hall sensor 50 has a sensing portion 51 inserted through a hole 38a in one side of the stator for detecting the rotation speed of the double rotor.

The stator 30 includes cores 31 exposed opposite to outer magnets 11 on the outer rotor 10 and inner magnets 21 on the inner rotor 20 and from an inside and an outside of the stator 30, respectively. It is preferable that the outer magnets 11 and the inner magnets 21 are permanent magnets and the cores 31 are electromagnets.

According to this, because rotating magnetic fields are formed doubly between the inner magnets 21 and the insides of the cores 31 and between the outer magnets 11 and the outsides of the cores 31, the double type rotor can be rotated with a stronger torque.

The stator 30 has a plurality of individual split cores 31, an insulator 32 of an insulating resin encapsulating each of the cores 31, a coil 34 wound on an outside of the insulator 32, and a molded portion 35c insert molded to outside surfaces of the insulator 32 and the coil 34. If the coil 34 has an insulating material, such as enamel, applied to the outside of the coil 34 to secure an electrical insulation, no insulator 32 may be provided, separately.

The outer rotor 10 has the inner magnets 11 of a plurality of permanent magnets having N poles and S poles arranged on an inside circumferential surface in a circumferential direction, alternately. The inner rotor 20 has the outer magnets of a plurality of permanent magnets having N poles and S poles arranged on an outside circumferential surface in a circumferential direction alternately opposite to the inner magnets 21. It is preferable that lower portions of the outer rotor 10 and the inner rotor 20 in contact to each other are pined by a caulking hole portion 23 formed by pressing and caulking.

Though the inner rotor 20 and the outer rotor 10 may be formed by injection molding, it is preferable that the inner rotor 20 and the outer rotor 10 are formed of metal for serving as back yokes.

A structure for mounting the double rotor type motor will be described.

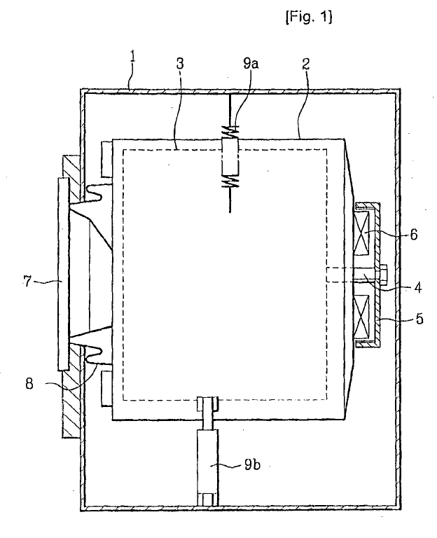

Referring to FIG. 2, the drum 3 or the pulsator or the like, rotatably mounted to a center of a rear of the tub 2 (see FIG. 1) of the washing machine, is connected to the rotation shaft 4. The rotation shaft 4 is rotatably supported on bearings 2b in the bearing housing 70 on a rear of the tub 2. The rotation shaft 4 has an end connected to a bushing 10 of resin at a center of the outer rotor 10. Though the bushing 40 is fixedly secured to a center of the outer rotor 10 with fastening means, such as bolts 42, the bushing 40 may be formed as one unit with the outer rotor 10 by a method, such as insert molding.

The bushing 40 has a hole at a center for placing the rotation shaft 4 therein, with a bushing side serration 41 on an inside circumferential surface for engagement with the serration 4a on an outside circumferential surface of the rotation shaft 4.

In the meantime, for fastening the stator 30 to the bearing housing 70, it is preferable that the stator 30 has a fixing portion 35 extended inwardly from the molded portion 33 in a radial direction. Of course, different from what is shown in the drawing, the fixing portion 35 may be extended outwardly from the molded portion 33 in a radial direction.

The fixing portion 35 is formed as one unit with the molded portion 33 by insert molding, and has a plurality of fastening holes 35a at predetermined angular intervals in a circumferential direction. The bearing housing 70 also has fastening holes 2c in correspondence to the fastening holes 35a in the fixing portion 35, so that the stator 30 is fixedly secured to the bearing housing 70 as fastening members, such as tolls 39, or the like, are passed through the fastening holes 35a, and 2c, and fastened.

Moreover, it is preferable that the fixing portion 35 has a reinforcing portion of a plurality of reinforcing ribs 35c on an outside surface for reinforcing strength of the fixing portion 35. It is preferable that reinforcing ribs 35d are formed at an inside corner of a point where the molded portion 33 and the fixing portion 35 meet as far as the reinforcing ribs 35d do not interfere rotation of the inner rotor 20.

Of course, without forming the reinforcing ribs 35c as described before, an annular metal bracket (not shown) may be attached to an inside or outside surface of the fixing portion 35 for reinforcing the molded portion 33.

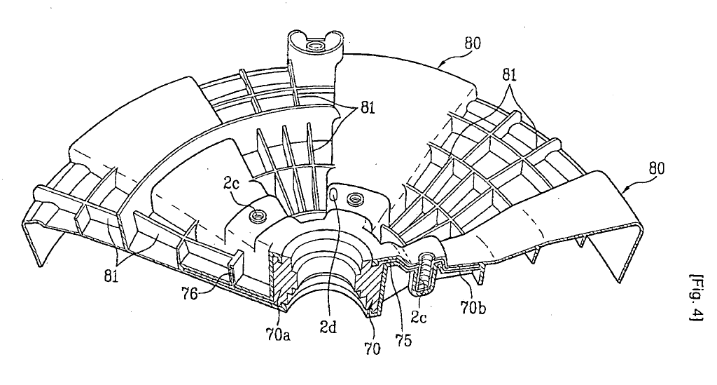

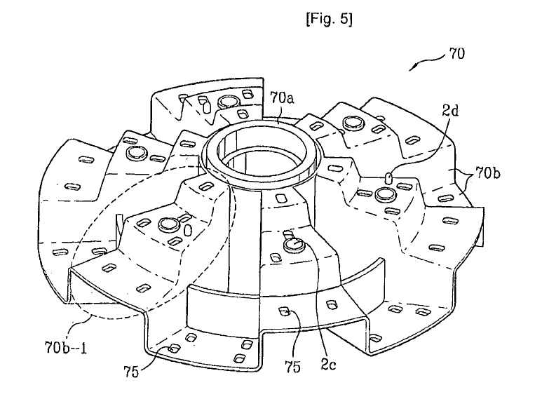

FIG. 4 illustrates a partial cut-away perspective view of a rub rear portion in accordance with a preferred embodiment of the present invention, and FIG. 5 illustrates a perspective view of a bearing housing in accordance with a preferred embodiment of the present invention.

Referring to FIG. 4, on an outside of the bearing housing of metal, such as an aluminum alloy, there is a cover 80, preferably insert molded with the tub 2 as one body. That is, in a state the bearing housing 70 is positioned at one side, the tub 2 and the cover 80 are formed at a time.

Referring to FIG. 5, the bearing housing 70 has fastening portions 70b extended in a radial pattern from an outside circumferential surface of a supporting portion 70a each projected at a predetermined height. When the cover (see 80 in FIG. 4) is insert molded on the bearing housing 70, the fastening holes 2c in the fastening portion 70 are exposed.

According to this, the bearing housing 70 is fixedly secured to the rear of the tub 2 by the cover 80, and at the same time with this, strength of the rear of the tub 2 can be reinforced. Therefore, because the cover 80 is formed at the same time with the insert molding for forming the rub 2, separate members for fastening the bearing housing 70 can be dispensed with, thereby improving productivity.

In the meantime, it is preferable that the cover 80 has a plurality of ribs 81 in a circumferential direction and a radial direction of a rear of the tub 2 respectively at predetermined intervals for reinforcing the cover 80.

Referring to FIG. 5, the bearing housing 70 includes a supporting portion 70a of a sleeve shape for supporting bearings, and fastening portion 70b extended from a rear end of the bearing supporting portion 70a in a radial direction as one body with the supporting portion 70a. As described before, the cover (see 80 in FIG. 4) is insert molded as one body with outside surfaces of the supporting portion 70a and the fastening portion 70b in rear of the tub 2.

The fastening portion 70b includes a region 70b-1 stepped at least once as it goes outward along a radial direction, and a flat region between the stepped regions 70b-1. It is preferable that the stepped region 70b-1 is bent downward as the stepped region 70b-1 goes outward in the radial direction at predetermined intervals.

Moreover, the bearing housing 70 has holding holes 75 in a periphery for improving bonding force with the cover 80 at the time of insert molding. A molding material is filled in the holding holes 75 at the time of insert molding of the cover 80. Accordingly, the bearing housing 70 is rigidly fixed to the cover 80.

The supporting portion 70a has a central hold for placing the rotation shaft, and the fastening portion 70b is extended outward in a radial direction of the supporting portion 70a. It is preferable that a plurality of the fastening portions 70b are formed as one body with the supporting portion 70a in a circumferential direction of the supporting portion 70a at predetermined angular intervals in a radial pattern.

The fastening portion 70b is projected at a predetermined height for reinforcing the bearing housing 70 and fastening to the fixing portion 35 at the stator 30.

As described before, the fastening portion 70b has fastening holes 2c at positions in correspondence to the fastening holes in the fastening portion 70b of the stator 30.

In the meantime, it is required that the stator 30 is coupled to the bearing housing 70 with an exact concentricity with respect to the rotation shaft 4. For this, both she fixing portion 35 and the fastening portion 70b have a positioning unit for aligning the concentricity.

Referring to FIGS. 2 to 4, the positioning unit includes positioning projections 2d and positioning holes 35b. A plurality of the positioning projections 2d are formed projected from one side of each of the fastening holes 2c in the fastening portion 70b of the bearing housing 70 at predetermined intervals. It is preferable mat the fixing portion 35 has the positioning holes 35b formed therein in correspondence to the positioning projections 2d such that the positioning projections 2d fit to the positioning holes 35b. The positioning holes 35b may be pass through holes formed to pass through the fixing portion 35.

Of course, opposite to above, the positioning holes may be formed in the fastening portion of the bearing housing 70, and the positioning projections may be formed on the fixing portion 35.

The positioning projection 2d includes a cylindrical body portion, and a conical guide portion at an end of the body portion for easy placing of the positioning projection in the positioning hole 35b.

It is preferable that the positioning hole 35b is formed in conformity with a shape of the positioning projection 2d so that the positioning projection 2d fits in the positioning hole 35b without movement once the positioning projection 2d is placed in the positioning hole 35b.

That is, it is preferable that a portion of the positioning hole 35b where the body portion of the positioning projection 2d is to be placed therein is cylindrical in correspondence to the body portion, and a portion where the guide portion of the positioning projection 2d is to be placed therein is conical. It is also preferable that the positioning hole 35b in the fixing portion 35 has a diameter smaller than a diameter of the fastening hole 35a.

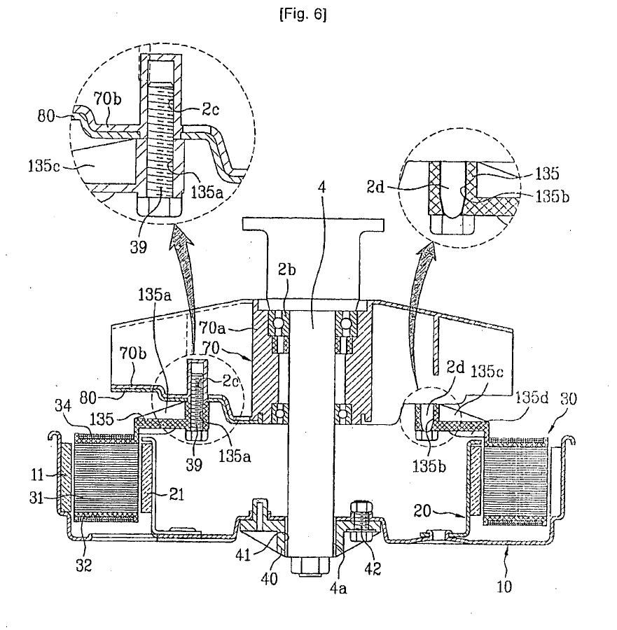

In the meantime, FIG. 6 illustrates a section of a structure for mounting a double rotor type motor in accordance with another preferred embodiment of the present invention.

Referring to FIG. 6, the double rotor type motor of the embodiment includes no molded portion formed individually at the stator 30, but a fixing portion 135 extended from the insulator 32 on an outside surface of the core 31. Because the bearing housing 70 and the cover 80 mounted to the rear of the tub 2 have structures the same with the foregoing embodiment, description of which will be omitted. The reinforcing ribs and the positioning unit at the fastening portion are the same with the foregoing embodiment.

As shown, the fixing portion 135 of the stator 30, pined with the fastening portion 70b of the bearing housing 70, is extended inwardly in a radial direction from the insulator 32. Of course, different from what is shown, the fixing portion may be extended outwardly in a radial direction from the insulator 32.

It is preferable that the fixing portion 135 is insert molded with the insulator 32 as one body. Moreover, the fixing portion 135 has reinforcing ribs 135a for reinforcing the fixing portion 135.

As described, the double rotor type motor of the present invention is fastened, and secured to the bearing housing at the rear of the tub, and the bearing housing can be rigidly secured covered with the cover insert molded with the tub as one body.

### MODE FOR THE INVENTION

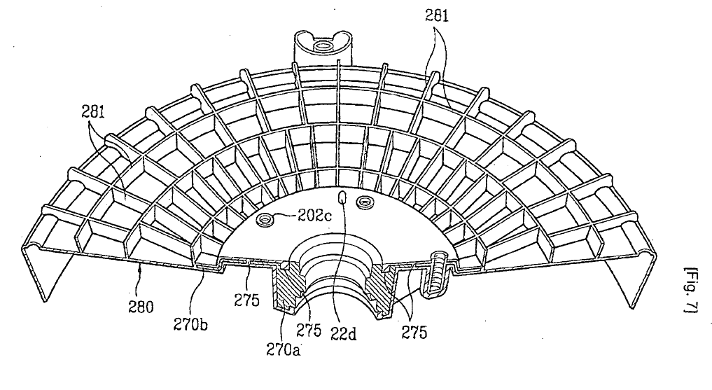

FIG. 7 illustrates a partial cut-away perspective view of a rear of a tub of a washing machine having a double rotor type motor in accordance with another preferred embodiment of the present invention.

Referring to FIG. 7, formed on an outside surface of a bearing housing 270 of an aluminum alloy or the like, there is a cover 280 insert molded with the tub 2.

That is, in a state the bearing housing 270 is positioned at one side, the tub 2 and the cover 280 are formed at a time. In this instance, it is preferable that only the fastening holes 202c in the fastening portion 270 are exposed. According to this, the bearing housing 270 is fixedly secured to the rear of the tub 2 by the cover 280, and at the same time with this, strength of the rear of the tub 2 can be reinforced. Therefore, because the cover 280 is formed at the same time with the insert molding for forming the tub 2, separate members for fastening the bearing housing 270 can be dispensed with, thereby improving productivity.

In the meantime, it is preferable that the cover 280 has a plurality of ribs 281 in a circumferential direction and a radial direction of a rear of the tub, respectively at pre-determined intervals for reinforcing the cover 280.

Referring to FIG. 7, the bearing housing 270 includes a supporting portion 270a of a substantially cylindrical shape for supporting bearings. The supporting portion 270a′ has bearings mounted on an inside for supporting the rotation shaft, and, as described before, the cover 280 on an outside insert molded to the rear of the tub as one body.

Formed in an upper surface of the supporting portion 270a, there are fastening holes 202c at positions in correspondence to the fastening holes in the fixing portion of the stator.

In the meantime, the bearing housing 270 has holding holes 275 in a periphery for enhancing bonding force with the cover 280 at the time of insert molding. The holding holes 275 has molding material filled therein at the lime of insert molding of the cover 280, to bond the bearing housing 270 and the cover 280 together.

There is a circular fastening portion 270b extended in a radial from the outside circumference of the supporting portion 270a for increasing an area the cover 280 covers. By this, the bearing housing 270 is secured to the rear of the tub more rigidly by the cover 280. It is possible that the fastening portion 270b is covered with the cover 280, and the supporting portion 270a is exposed to an outside. In this case, a problem can be prevented, in that resin flews in the fastening holes 202c in the supporting portion 270a at the time of insert molding, to cause defects.

In the embodiment, the fastening portion 270b is extended from the supporting portion 270a in a radial direction with steps, and in a flat simple shape in a circumferential direction without the steps. The flat simple shape without the steps, to have a simple structure, permits to save a material cost, and a mold cost in fabrication, and to secure more space in the tub.

In the meantime, it is required that the stator is coupled with an accurate concentricity with respect to the rotation shaft. For this, the fixing portion and the supporting portion 270a are provided with a positioning unit for aligning the con centricity.

### INDUSTRIAL APPLICABILITY

The present invention relates to washing machines with double rotor type motors, and more particularly, to a washing machine with a double rotor type motor in which a structure for mounting a bearing housing thereof is enhanced. The washing machine of the present invention having the double rotor type motor applied thereto has the following advantages.

First, the securing of the bearing housing with the cover insert molded with the tub as one body permits to secure the double rotor type motor that provides a high torque, securely.

Second, the securing of the bearing housing with the cover, covering the bearing housing, insert molded with the tub as one body permits to omit the step for mounting the bearing housing to the rear of the tub. According to this, the assembly process can be simplified, to shorten a production time period of the product.

Third, the fastening portion extended from the supporting portion of the bearing housing in a radial pattern is coupled to the stator and reinforces the rear of the tub.

Fourth, if the supporting portion of the bearing housing is exposed to an outside at the time of insert molding of the cover, the flow of the molding material into the fastening holes in the supporting portion can be prevented, thereby preventing defects from taking place.

Fifth, the shortening of a time period required for aligning the bearing housing and the stator by using the positioning unit permits to shorten a production time period.

1. A washing machine comprising:
a tub for holding washing water;
a double rotor having an outer rotor with outer magnets supported on an inside circumferential surface, and an inner rotor inside the outer rotor with inner magnets supported on outside circumferential surface;
a bearing housing at a rear of the tub, having a supporting portion for supporting a rotation shaft connected to the double rotor;
a cover insert molded with the tub as one body therewith, to cover an outside surface of the bearing housing; and
a stator having cores with opposite surfaces arranged to face the outer magnets and the inner magnets respectively, a coil wound on an outside surface of each of the cores, a molded portion insert molded to outside surfaces of the core and coil so as to be exposed to the surfaces of the core, and a fixing portion extended from the molded portion and secured to the fastening portion.

2. The washing machine as claimed in claim 1, wherein the bearing housing further having a fastening portion extended from the supporting portion in a radial direction.

3. The washing machine as claimed in claim 2, wherein a plurality of the fastening portions are formed in a circumferential direction of the bearing housing at pre-determined angular intervals.

4. The washing machine as claimed in claim 3, the bearing housing further comprising vertical ribs between the plurality of fastening portions.

5. The washing machine as claimed in claim 2, wherein the fastening portion has holding holes.

6. The washing machine as claimed in claim 1, wherein the fixing portion is insert molded with the molded portion as one body.

7. The washing machine as claimed in claim 1, wherein the fixing portion is extended from the molded portion inwardly in a radial direction.

8. The washing machine as claimed in claim 1, wherein the fastening portion and the fixing portion each has at least one fastening hole at positions corresponding to each other for fastening a fastening member.

9. The washing machine as claimed in claim 1, wherein the fastening portion is stepped in a radial direction.

10. The washing machine as claimed in claim 1, further comprising a positioning unit for determining a fixing position of the fixing portion with respect to the fastening portion.

11. The washing machine as claimed in claim 10, wherein the positioning unit includes;
at least one positioning projection projected from one of the fixing portion and the fastening portion, and
at least one positioning hole formed in the other one of the fixing portion and the fastening portion in correspondence to the positioning projection.

12. The washing machine as claimed in claim 11, wherein the positioning projection includes;
a cylindrical body portion, and
a guide portion at an end of the body portion having a diameter reduced the more as it goes toward an end the more.

13. The washing machine as claimed in claim 11, wherein the positioning hole includes;
a cylindrical portion in correspondence to the body portion, and
a reduced portion at an end of the cylindrical portion in correspondence to the guide portion.

14. The washing machine as claimed in claim 11, wherein the positioning hole has a diameter smaller than a diameter of the fastening hole in the fixing portion.

15. The washing machine as claimed in claim 1, wherein the bearing housing has holding holes for filling molding material therein at the time of insert molding of the cover, for bonding the bearing housing and the cover together.

16. The washing machine as claimed in claim 1, wherein the fixing portion includes a reinforcing portion for reinforcing strength of the fixing portion.

17. The washing machine as claimed in claim 16, wherein the reinforcing portion includes a plurality of reinforcing ribs at an outside surface of the fixing portion as one body therewith.

18. The washing machine as claimed in claim 1, wherein the cover includes a plurality of reinforcing ribs formed as one body therewith for reinforcing strength.

19. The washing machine as claimed in claim 1, further comprising an insulator of an insulating resin between the core and the molded portion.

20. A washing machine comprising:
a tub for holding washing water;
a double rotor having an outer rotor with outer magnets supported on an inside circumferential surface, and an inner rotor inside the outer rotor with inner magnets supported on outside circumferential surface;
a bearing housing at a rear of the tub, having a supporting portion for supporting a rotation shaft connected to the double rotor, and a fastening portion extended in a radial direction from the supporting portion;
a cover insert molded with the tub as one body therewith for covering an outside surface of the bearing housing and securing the bearing housing, having a plurality of reinforcing ribs for reinforcing strength; and
a stator having cores with opposite surfaces arranged to face the outer magnets and the inner magnets respectively, an insulator of insulating resin on an outside surface of the core, a coil wound on an outside surface of the insulator, a molded portion insert molded to outside surfaces of the core and coil so as to be exposed to the surfaces of the core, and a fixing portion extended from the molded portion in a radial direction and secured to the fastening portion.

21. A washing machine comprising:
a tub for holding washing water;
a double rotor having an outer rotor with outer magnets supported on an inside circumferential surface, and an inner rotor inside the outer rotor with inner magnets supported on an outside circumferential surface;
a bearing housing at a rear of the tub, having a supporting portion for supporting a rotation shaft connected to the double rotor, and a fastening portion extended in a radial direction from the supporting portion;
a cover insert molded with the tub as one body therewith for covering an outside surface of the bearing housing and securing the bearing housing, having a plurality of reinforcing ribs for reinforcing strength; and
a stator having cores with opposite surfaces arranged to face the outer magnets and the inner magnets respectively, an insulator of insulating resin on an outside surface of the core, a coil wound on an outside surface of the insulator, and a fixing portion extended from the insulator in a radial direction and secured to the fastening portion.
